(19) United States
(12) Patent Application Publication
(10) Pub. No.: US 2025/0282002 A1
(43) Pub. Date: Sep. 11, 2025

(54) JOINING METHOD OF DISSIMILAR METAL PLATES, JOINING APPARATUS AND JOINED BODY

(71) Applicant: Mazda Motor Corporation, Aki-gun (JP)

(72) Inventors: Shintaro Anzai, Aki-gun (JP); Akira Hashimoto, Aki-gun (JP)

(21) Appl. No.: 19/044,862

(22) Filed: Feb. 4, 2025

(30) Foreign Application Priority Data
Mar. 11, 2024 (JP) 2024-037209

(51) Int. Cl. B23K 26/323; B23K 26/21; F16B 5/08

(52) U.S. Cl. CPC B23K 26/323; B23K 26/21; F16B 5/08

(57) ABSTRACT

A method of joining a first metal plate and a second metal plate made of different materials, includes, a placement step of forming an overlapping area where the first and second metal plates are overlapped with each other, and a laser welding step of irradiating a laser beam onto the overlapping area and reciprocating the laser irradiation point in a first direction, while moving the irradiation point in a second direction perpendicular to the first direction to form a welded part along a sine-wave-shaped irradiation locus having an amplitude. In the welding step, a plurality of irradiation loci are drawn so as to be separated from each other in the first direction, and when seen in the second direction, one of the irradiation loci adjacent in the first direction to another irradiation locus is overlapped within a range of the amplitude of the other irradiation locus.

### TECHNICAL FIELD

The present disclosure relates to a joining method of dissimilar metal plates, a joining apparatus, and a joined body.

### BACKGROUND OF THE DISCLOSURE

JP6998630B1 discloses an art for joining dissimilar metal plates made of different materials, such as copper and aluminum. This art irradiates a laser beam onto an overlapping area of a first metal plate and a second metal plate to form a welded part in the overlapping area by heat caused by the irradiation of the laser beam.

When an irradiation locus of the laser beam in the overlapping area of the dissimilar metal plates draws a route including a nonlinear section, such as a sine-wave shape, it is difficult to maintain a constant moving speed of the irradiation point of the laser beam throughout the irradiation locus. In this case, since some parts with insufficient welding widths and depths may be produced in the welded part (where the welding volume is small) formed along the irradiation locus of the laser beam, the joint strength of the dissimilar metal plates may be lowered.

### SUMMARY OF THE DISCLOSURE

Therefore, one purpose of the present disclosure is to provide a joining method of dissimilar metal plates, a joining apparatus, and a joined body, which are capable of increasing a joint strength of the dissimilar metal plates.

A method of joining dissimilar metal plates comprised of a first metal plate and a second metal plate that are made of different materials is provided. The method includes a placement step of forming an overlapping area where the first metal plate and the second metal plate are placed so as to be overlapped with each other, and a laser welding step of irradiating a laser beam onto the overlapping area, and reciprocating an irradiation point of the laser beam onto the overlapping area in a perpendicular direction perpendicular to a given direction, while moving the irradiation point in the given direction to form a welded part in the overlapping area along an irradiation locus of a sine-wave shape having a given amplitude in the perpendicular direction. In the laser welding step, the laser beam is irradiated onto the overlapping area so that a plurality of irradiation loci are drawn so as to be separated from each other in the perpendicular direction, and when seen in the given direction, one of the irradiation loci adjacent to another of the irradiation loci in the perpendicular direction is overlapped within a range of the amplitude of the other irradiation locus.

In the laser welding step, the laser beam may be irradiated onto the overlapping area so that three or more irradiation loci are drawn with the same amplitude, without shifting phase, and a pitch of the centers of the amplitudes is an equal interval.

In the laser welding step, when drawing the plurality of irradiation loci, the laser beam may be irradiated onto the overlapping area on a basis of the irradiation locus drawn in a first time so that the irradiation loci in and after a second time are drawn alternatingly on either side in the perpendicular direction.

In the laser welding step, the laser beam may be irradiated onto the overlapping area so that the plurality of irradiation loci are all drawn in one way in the given direction.

In the laser welding step, a ratio of the amplitude to the pitch may be set within a range of 1.3 or more and 3.3 or less for the plurality of irradiation loci.

A joining apparatus configured to join dissimilar metal plates comprised of a first metal plate and a second metal plate that are made of different materials is provided. The apparatus includes a support base configured to form an overlapping area where the first metal plate and the second metal plate are placed so as to be overlapped with each other, a laser oscillator configured to oscillate a laser beam, and a scanner configured to irradiate the laser beam oscillated by the oscillation module onto the overlapping area, and reciprocating an irradiation point of the laser beam onto the overlapping area in a perpendicular direction perpendicular to a given direction, while moving the irradiation point in the given direction to form a welded part in the overlapping area along an irradiation locus of a sine-wave shape having a given amplitude in the perpendicular direction. The irradiation module irradiates the laser beam onto the overlapping area so that a plurality of irradiation loci are drawn so as to be separated from each other in the perpendicular direction, and when seen in the given direction, one of the irradiation loci adjacent to each other in the perpendicular direction is overlapped within a range of the amplitude of the other irradiation locus.

A joined body of dissimilar metal plates, formed by joining a first metal plate and a second metal plate that are made of different materials is provided. The joined body includes an overlapping area wherein the first metal plate and the second metal plate are overlapped with each other, and a plurality of welded parts, each formed in the overlapping area, extending in a given direction, and having a sine-wave shape with given amplitude in a perpendicular direction perpendicular to the given direction. The plurality of welded parts are separated from each other in the perpendicular direction, and when seen in the given direction, the sine-wave shape of one of the welded parts adjacent to another of the welded parts in the perpendicular direction is overlapped within a range of the amplitude of the sine-wave shape of the other welded part.

### BRIEF DESCRIPTION OF DRAWINGS

FIG. 1 is a perspective view schematically illustrating a configuration of a joining apparatus according to one embodiment of the present disclosure.

FIGS. 2A and 2B are views illustrating a joining method according to this embodiment.

FIG. 3A is an enlarged view of a S part in FIG. 2A, and FIGS. 3B and 3C are enlarged cross-sectional views of S1 and S2 parts in FIG. 3, respectively.

FIG. 4 is a view illustrating a relationship between amplitude and a pitch in a plurality of irradiation loci.

FIG. 5A is a view illustrating a joined body according to this embodiment, and FIG. 5B is an enlarged view of a SS part in FIG. 5A.

### DETAILED DESCRIPTION OF THE DISCLOSURE

Hereinafter, a joining method, a joining apparatus, and a joined body of dissimilar metal plates according to one embodiment will be described with reference to the accompanying drawings. Below, about the directions, a given direction is referred to as a “given direction Y,” a direction perpendicular to the given direction Y in a horizontal plane is referred to be as a “perpendicular direction X,” and a direction vertical to the given direction Y and the perpendicular direction X is referred to be as an “up-and-down direction Z.”

### [Joining Apparatus]

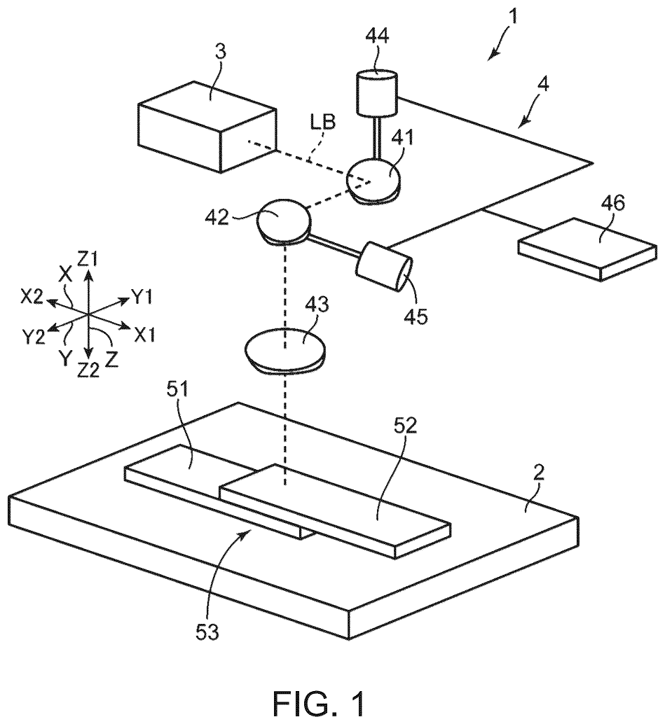

FIG. 1 is a perspective view schematically illustrating a configuration of a joining apparatus 1 according to this embodiment. The joining apparatus 1 is a joining apparatus of dissimilar metal plates which joins a first metal plate 51 and a second metal plate 52 which are made of different materials. The joining apparatus 1 irradiates a laser beam LB onto an overlapping area 53 where the first metal plate 51 and the second metal plate 52 overlap with each other in the up-and-down direction Z to melt and solidify the overlapping area 53 locally, and join the first metal plate 51 and the second metal plate 52 in the overlapping area 53. In detail, when the laser beam LB is irradiated onto the overlapping area 53, the overlapping area 53 is melted locally by heat accompanying the irradiation of the laser beam LB, and the overlapping area 53 is then solidified to join the first metal plate 51 and the second metal plate 52.

The first metal plate 51 may be made of aluminum or an aluminum alloy, and may be formed into a flat-plate-like object with a given thickness. The second metal plate 52 may be made of copper or a copper alloy, and may be formed into a flat-plate-like object with a given thickness.

The joining apparatus 1 is provided with a placement module 2, an oscillation module 3, and an irradiation module 4.

The placement module 2 is a module for forming the overlapping area 53 where the first metal plate 51 and the second metal plate 52 overlap with each other in the up-and-down direction Z, mainly by taking the form of a support base. When the first metal plate 51 and the second metal plate 52 are placed on the placement module 2, the overlapping area 53 where the first metal plate 51 and the second metal plate 52 overlap with each other is formed. In the overlapping area 53, the second metal plate 52 may be superimposed on the first metal plate 51, or the first metal plate 51 may be superimposed on the second metal plate 52. In this embodiment, in the overlapping area 53, the second metal plate 52, which is high in thermal conductivity is superimposed on the first metal plate 51.

The oscillation module 3 is a laser oscillator which oscillates the laser beam LB. The oscillation module 3 may oscillate a laser selected from a CO₂ laser, an yttrium aluminum garnet (YAG) laser, a semiconductor laser, a fiber laser, or a laser diode (LD) excitation solid-state laser, for the laser beam LB.

The irradiation module 4 is a module which irradiates the laser beam LB oscillated by the oscillation module 3 onto the overlapping area 53. The irradiation module 4 reciprocates an irradiation point of the laser beam LB in the perpendicular direction X, while moving the irradiation point in the given direction Y to form a welded part in the overlapping area 53, while drawing an irradiation locus of a given shape.

The irradiation module 4 may be comprised of a scanner such as a Galvano scanner. In this case, the irradiation module 4 includes a first mirror 41, a second mirror 42, a condenser lens 43, an X-axis motor 44, a Y-axis motor 45, and a control driver 46. The first mirror 41 is a mirror which reflects the laser beam LB, and is pivotably driven by the X-axis motor 44. The first mirror 41 is rotated by the X-axis motor 44 to change a reflection direction of the laser beam LB to reciprocate the irradiation point of the laser beam LB with respect to the overlapping area 53 in the perpendicular direction X. The second mirror 42 is a mirror which reflects the laser beam LB reflected by the first mirror 41, and is pivotably driven by the Y-axis motor 45. The second mirror 42 is rotated by the Y-axis motor 45 to change the reflection direction of the laser beam LB, and moves the irradiation point of the laser beam LB with respect to the overlapping area 53 in the given direction Y The condenser lens 43 is a lens which condenses or collects the laser beam LB reflected by the second mirror 42, and leads the condensed laser beam to the overlapping area 53. The control driver 46 controls the X-axis motor 44 and the Y-axis motor 45 to reciprocate the irradiation point of the laser beam LB in the perpendicular direction X, while moving the irradiation point with respect to the overlapping area 53 in the given direction Y

### [Joining Method]

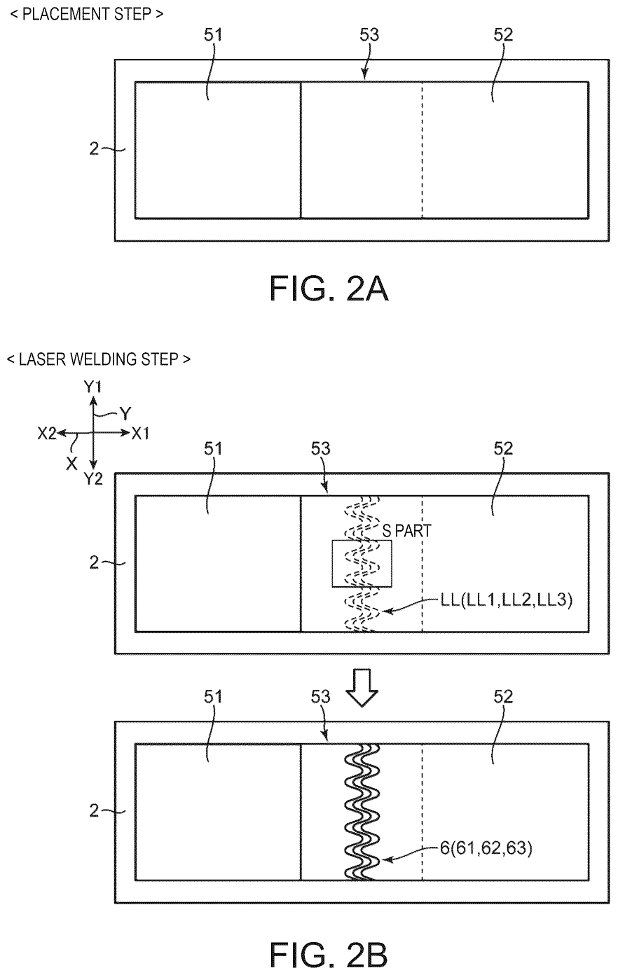

The joining method of the dissimilar metal plates according to this embodiment is now described with reference to FIGS. 2A to 4. This joining method may be implemented using the above-described joining apparatus 1. The joining method includes a placement step and a laser welding step.

As illustrated in FIG. 2A, in the placement step, the first metal plate 51 and the second metal plate 52 are placed on the placement module 2 (support base) A so that the overlapping area 53 where the first metal plate 51 and the second metal plate 52 are overlapped with each other is formed. This placement of the first metal plate 51 and the second metal plate 52 onto the placement module 2 may be performed automatically by the placement module 2, or may be carried out by a human operator.

As illustrated in FIG. 2B, in the laser welding step, the irradiation module 4 irradiates the laser beam LB oscillated by the oscillation module 3 onto an upper surface of the overlapping area 53. The irradiation module 4 irradiates the laser beam LB onto the upper surface of the overlapping area 53 through the condenser lens 43 based on the rotation of the first mirror 41 and the second mirror 42 according to the control of the X-axis motor 44 and the Y-axis motor 45 by the control driver 46.

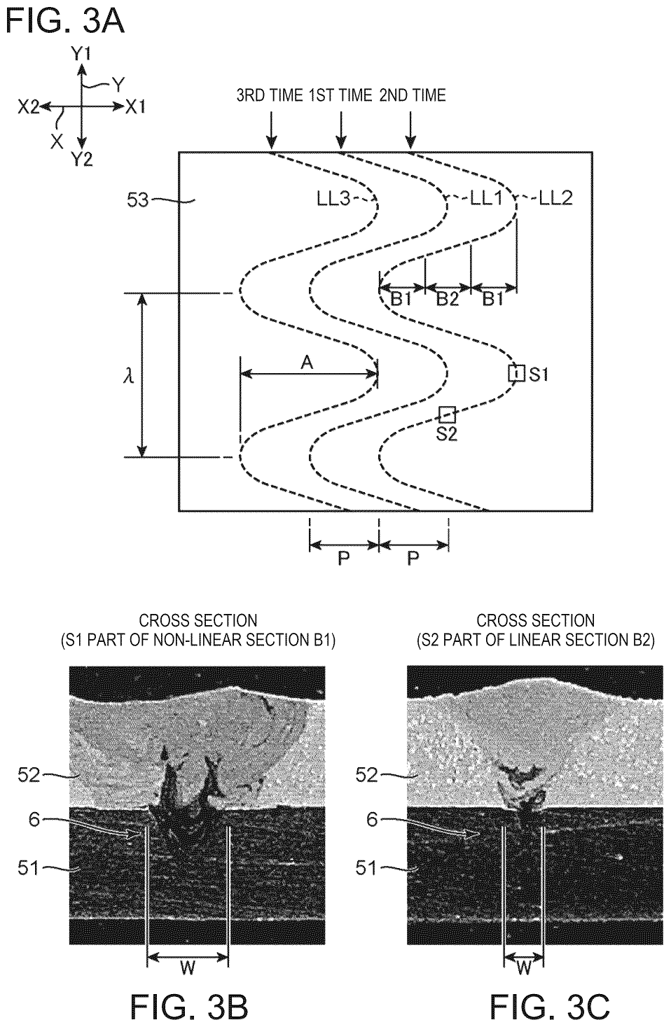

In the laser welding step, the irradiation module 4 reciprocates the irradiation point of the laser beam LB with respect to the upper surface of the overlapping area 53 in the given direction Y, while moving the irradiation point in the perpendicular direction X to form a welded part 6 along an irradiation locus LL of a sine-wave shape with a given amplitude A (see FIG. 3A) in the perpendicular direction X. As illustrated in FIGS. 2B and 3A, the sine-wave-shaped irradiation locus LL may have the shape of a sine wave with a wavelength k in the given direction Y and the amplitude A in the perpendicular direction X, or may have the shape of a triangle wave or a sawtooth wave similar to the sine wave. Further, in this embodiment, the amplitude A of the irradiation locus LL is a so-called “peak-to-peak amplitude” which is defined by a distance in the perpendicular direction X from a crest peak of the sine wave to an adjacent valley peak. That is, the range of the amplitude A of the irradiation locus LL is a range from a crest peak point to a valley bottom (peak) point of the sine-wave shape.

In the laser welding step, the irradiation module 4 irradiates the laser beam LB to draw the sine-wave-shaped irradiation locus LL in the overlapping area 53 so that it forms the welded part 6 along the irradiation locus LL. As illustrated in FIGS. 2B and 3A, the sine-wave-shaped irradiation locus LL becomes a locus within a range of the amplitude A of the sine-wave shape, which is comprised of a nonlinear section B1 with a curve including a peak of a crest or a valley, and a linear section B2 with a straight line connecting one nonlinear section B1 to another nonlinear section B1 including the center of the amplitude A (the center of the wave). A moving speed of the irradiation point of the laser beam LB when drawing the irradiation locus LL is normally set faster in the linear section B2 than in the nonlinear section B1. In this case, since, the width W and the depth of the welded part 6 formed along the irradiation locus LL of the laser beam LB, they become smaller in the linear section B2 than in the nonlinear section B1, the welding volume of the welded part 6 along the irradiation locus LL becomes smaller in the linear section B2 than in the nonlinear section B1 (see the cross-sectional views in FIGS. 3A and 3B). For this reason, the joint strength of the dissimilar metal plates, which are the first metal plate 51 and the second metal plate 52, may be lowered.

Thus, the irradiation module 4 irradiates the laser beam LB onto the overlapping area 53 so that the laser beam LB draws a plurality of irradiation loci LL which are separated from each other in the perpendicular direction X, and the nonlinear section B1 including a peak of the crest or valley of one of irradiation loci LL which are adjacent to each other in the perpendicular direction X overlaps with the range of amplitude A of the other irradiation locus LL, when seen in the given direction Y Therefore, when seen in the given direction Y, it is possible to overlap the nonlinear section B1 including a peak of the crest or valley of one of the irradiation loci LL which are adjacent to each other in the perpendicular direction X with the linear section B2 within the range of the amplitude A of the other irradiation locus LL. For this reason, in the welded part 6 formed along each of the plurality of irradiation loci LL, the linear section B2 with small welding volume can be reinforced by the nonlinear section B1 with a large welding volume, when seen in the given direction. This increases the joint strength of the dissimilar metal plates (the first metal plate 51 and the second metal plate 52).

In this embodiment, in the laser welding step, the irradiation module 4 irradiates the laser beam LB onto the overlapping area 53 to draw three or more irradiation loci LL with the same amplitude A, without shifting the phase, so that a pitch P between the centers of the amplitude A (the centers of the waves) becomes equal. In the example of FIG. 3A, the irradiation module 4 irradiates the laser beam LB to the overlapping area 53 to draw the three irradiation loci LL (a first irradiation locus LL1, a second irradiation locus LL2, and a third irradiation locus LL3) with the same amplitude A, without shifting the phase, so that the irradiation loci LL are separated from each other in the perpendicular direction X at the equal pitch P. The irradiation module 4 draws the second irradiation locus LL2 at a position adjacent to the first irradiation locus LL1 on one side (direction X1) in the perpendicular direction X, and draws the third irradiation locus LL3 at a position adjacent to the first irradiation locus LL1 on the other side (direction X2) in the perpendicular direction X. In this case, when seen in the given direction Y, it is possible to more securely overlap the nonlinear sections B1 of the second irradiation locus LL2 and the third irradiation locus LL3 with the linear section B2 within the range of the amplitude A of the first irradiation locus LL1. For this reason, when one of the welded parts 6 formed along the first irradiation locus LL1 is referred to as a “first welded part 61 (FIG. 2B),” another welded part 6 formed along the second irradiation locus LL2 is referred to as a “second welded part 62 (FIG. 2B),” and another welded part 6 formed along the third irradiation locus LL3 is referred to as a “third welded part 63 (FIG. 2B),” the linear section B2 with a small welding volume (the first welded part 61) can be reinforced more securely by the nonlinear sections B1 with large welding volume (the second welded part 62 and the third welded part 63)), when seen in the given direction Y.

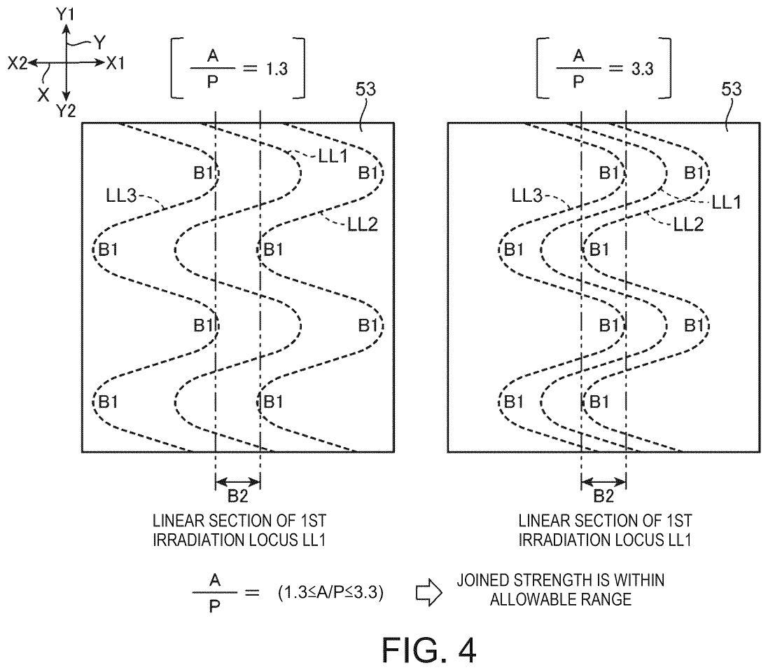

As illustrated in FIG. 4, in the laser welding step, the irradiation module 4 sets a ratio (A/P) of the amplitude A to the pitch P within a range of 1.3 or more and 3.3 or less (1.3≤A/P≤3.3) for the plurality of irradiation loci LL (the first irradiation locus LL1, the second irradiation locus LL2, and the third irradiation locus LL3).

By setting the ratio (A/P) to 1.3 or more, it is possible to overlap at least a part of the nonlinear sections B1 of the second irradiation locus LL2 and the third irradiation locus LL3 with the linear section B2 within the range of the amplitude A of the first irradiation locus LL1, when seen in the given direction Y. If the ratio (A/P) is set to less than 1.3, it may not be able to effectively overlap the nonlinear sections B1 of the second irradiation locus LL2 and the third irradiation locus LL3 with the linear section B2 within the range of the amplitude A of the first irradiation locus LL1.

However, by setting the ratio (A/P) to 3.3 or less, it is possible to overlap the nonlinear sections B1 of the second irradiation locus LL2 and the third irradiation locus LL3 with the linear section B2 within the range of the amplitude A of the first irradiation locus LL1, when seen in the given direction Y, and the linear sections B2 of the second irradiation locus LL2 and the third irradiation locus LL3 are suppressed from overlapping with each other. If the ratio (A/P) exceeds 3.3, the overlapping portions of the linear sections B2 of the second irradiation locus LL2 and the third irradiation locus LL3 with the linear section B2 of the first irradiation locus LL1 may increase.

As described above, the irradiation module 4 sets the ratio (A/P) within the range of 1.3 or more and 3.3 or less for the plurality of irradiation loci LL (the first irradiation locus LL1, the second irradiation locus LL2, and the third irradiation locus LL3). Thus, it is possible to overlap the nonlinear sections B1 of the second irradiation locus LL2 and the third irradiation locus LL3 with the linear section B2 within the range of the amplitude A of the first irradiation locus LL1 more securely, when seen in the given direction Y For this reason, in the first welded part 61, the second welded part 62, and the third welded part 63 which are formed along the first irradiation locus LL1, the second irradiation locus LL2, and the third irradiation locus LL3, respectively, the linear sections B2 with a small welding volume (the second welded part 62 and the third welded part 63) can be reinforced more securely by the nonlinear section B1 with a large welding volume (the first welded part 61), when seen in the given direction Y. This increases the joint strength of the dissimilar metal plates (the first metal plate 51 and the second metal plate 52).

As illustrated in FIG. 3A, when drawing the plurality of irradiation loci LL in the overlapping area 53, the irradiation module 4 irradiates the laser beam LB onto the overlapping area 53 so that, on the basis of the irradiation locus LL drawn on the first time, the irradiation loci LL on and after the second time are alternately drawn on one side X1 and the other side X2 in the perpendicular direction X. For example, when drawing the three irradiation loci LL (the first irradiation loci LL1, the second irradiation locus LL2, and the third irradiation locus LL3) in the overlapping area 53, the irradiation module 4 draws, on the basis of the first irradiation locus LL1 on the first time, draws the second-time second irradiation locus LL2 on one side X1 in the perpendicular direction X, and then draws the third-time third irradiation locus LL3 on the other side X2 in the perpendicular direction X. In this case, the third-time third irradiation locus LL3 may be drawn so that it is adjacent to the second-time second irradiation locus LL2 on the opposite side of the first-time first irradiation locus LL1. That is, the irradiation loci LL on and after the third time will be drawn adjacent to the irradiation locus LL drawn two times before. Thus, while the influence of the heat caused by the irradiation of the laser beam LB is reduced, the irradiation loci LL on and after the third time can be drawn. For this reason, a weld distortion on the welded part 6 resulting from the influence of the heat caused by the irradiation of the laser beam LB can be suppressed. This increases the joint strength of the dissimilar metal plates (the first metal plate 51 and the second metal plate 52).

The weld distortion on the welded part 6 resulting from the influence of the heat caused by the irradiation of the laser beam LB includes the weld distortion resulting from the thickness of the layer of the intermetallic compound generated in the welded part 6. When the first metal plate 51 is made of aluminum and the second metal plate 52 is made of copper, the intermetallic compound generated in the welded part 6 may include Cu₉Al₄, CuAl, and CuAl₂. Generally, regarding the strength of such intermetallic compounds, Cu₉Al₄ is the strongest, CuAl₂ is the weakest, and CuAl is intermediate. For this reason, if the thickness of the layer of CuAl₂ is large, the joint strength of the dissimilar metal plates may be lowered. Therefore, when drawing the plurality of irradiation loci LL in the overlapping area 53, it is necessary to reduce the influence of the heat caused by the irradiation of the laser beam LB as much as possible.

In the laser welding step, the irradiation module 4 irradiates the laser beam LB onto the overlapping area 53 so that the plurality of irradiation loci LL are drawn on one side Y1 in the given direction Y which goes from one side Y1 to the other side Y2. For example, when drawing the three irradiation loci LL (the first irradiation loci LL1, the second irradiation locus LL2, and the third irradiation locus LL3) in the overlapping area 53, the irradiation module 4 draws each locus from one side Y1 to the other side Y2 in the given direction Y.

In this case, as compared with a case where, after drawing the first irradiation locus LL1 from one side Y1 to the other side Y2 in the given direction Y, the second irradiation locus LL2 is then drawn from the other side Y2 to one side Y1 in a turn-back fashion, and the third irradiation locus LL3 is again drawn from one side Y1 to the other side Y2 in a turn-back fashion, the first irradiation locus LL1, the second irradiation locus LL2, and the third irradiation locus LL3 can be drawn with a sufficient interval therebetween. Thus, the first irradiation locus LL1, the second irradiation locus LL2, and the third irradiation locus LL3 can be drawn in the state where the influence of the heat caused by the irradiation of the laser beam LB is reduced. For this reason, the weld distortion on the welded part 6 resulting from the influence of the heat caused by the irradiation of the laser beam LB can be suppressed. This increases the joint strength of the dissimilar metal plates (the first metal plate 51 and the second metal plate 52).

### [Joined Body]

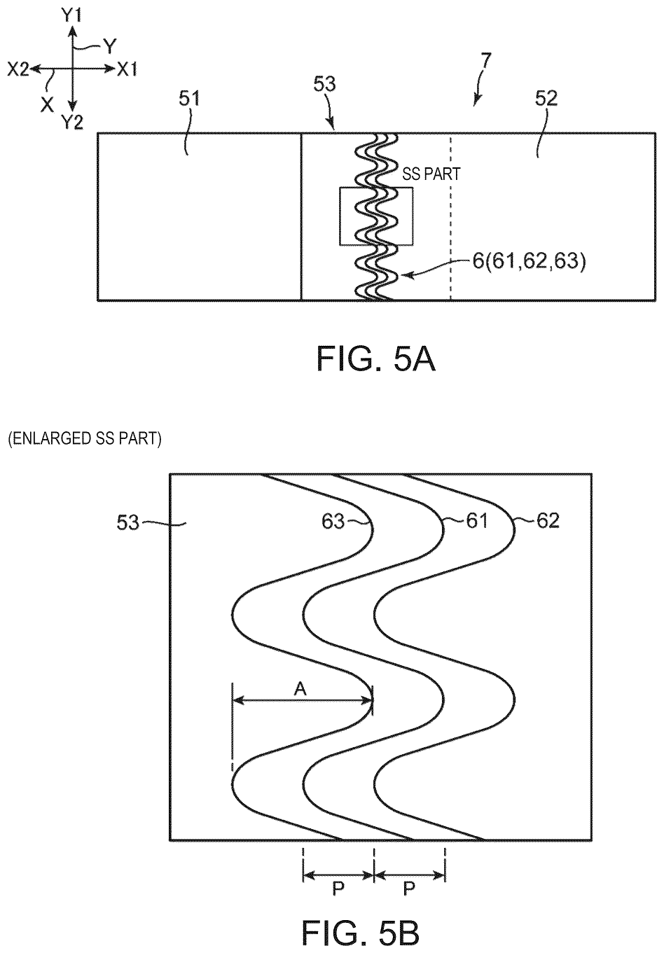

A joined body 7 of the dissimilar metal plates according to this embodiment is described with reference to FIGS. 5A and 5B. The joined body 7 of the dissimilar metal plates is produced by the joining method using the above-described joining apparatus 1. The joined body 7 is a joined body of the dissimilar metal plates where the first metal plate 51 and the second metal plate 52 which are made of different materials are joined.

The joined body 7 includes the overlapping area 53 where the first metal plate 51 and the second metal plate 52 are overlapped with each other, and the plurality of welded parts 6 formed in the overlapping area 53. On the upper surface of the overlapping area 53, the plurality of welded parts 6 which extend in the given direction Y and have the sine-wave shape with the given amplitude A in the perpendicular direction X perpendicular to the given direction Y. The plurality of welded parts 6 are separated from each other in the perpendicular direction X, and when seen in the given direction Y, and the wave shape of one of the welded parts 6 which are adjacent in the perpendicular direction X overlaps within the range of the amplitude A of the wave shape of the other welded part 6. Therefore, in the joined body 7, the joint strength of the dissimilar metal plates (the first metal plate 51 and the second metal plate 52) is increased.

In this embodiment, in the joined body 7, the plurality of welded parts 6 which are the three or more sine-wave-shaped waves with the same amplitude A, without shifting the phase, are formed in the overlapping area 53 so that the pitch P between the centers of the amplitudes A becomes equal. In the example of FIG. 5B, in the joined body 7, the first welded part 61, the second welded part 62, and the third welded part 63 along the shape of the three sine waves with the same amplitude A are formed in the overlapping area 53 so that the welded parts are separated from each other in the perpendicular direction X at the equal pitch P, without shifting the phase. On the upper surface of the overlapping area 53, the second welded part 62 is formed at the position adjacent to the first welded part 61 on one side X1 in the perpendicular direction X, and the third welded part 63 is formed at the position adjacent to the first welded part 61 on the other side X2 in the perpendicular direction X. In the first welded part 61, the second welded part 62, and the third welded part 63 formed on the upper surface of the overlapping area 53, the ratio (A/P) of the amplitude A to the pitch P is set within the range of 1.3 or more and 3.3 or less. Therefore, in the joined body 7, the joint strength of the dissimilar metal plates (the first metal plate 51 and the second metal plate 52) is increased more securely.

### Modified Embodiment(s)

As described above, although one embodiment is described, the present disclosure is not limited to this embodiment, and may be modified into the following embodiments.

Although in the above embodiment the irradiation module 4 of the joining apparatus 1 is comprised of the Galvano scanner, the present disclosure is not limited to such a configuration. The irradiation module 4 may have any configuration, as long as it can reciprocate the irradiation point of the laser beam LB onto the overlapping area 53 in the perpendicular direction X, while moving the irradiation point in the given direction Y. For example, the placement module 2 on which the first metal plate 51 and the second metal plate 52 are disposed may be movable in the given direction Y, and the irradiation module 4 may be swingable in the perpendicular direction X according to the movement of the placement module 2. In this case, the irradiation point of the laser beam LB on the overlapping area 53 is reciprocated in the perpendicular direction X according to the swing of the irradiation module 4, while moving in the given direction Y according to the movement of the placement module 2.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1 Joining Apparatus
2 Placement Module
3 Oscillation Module
4 Irradiation Module
51 First Metal Plate
52 Second Metal Plate
53 Overlapping Area
6 Welded Part
61 First Welded Part
62 Second Welded Part
63 Third Welded Part
7 Joined Body
LB Laser Beam
LL Irradiation Locus
LL1 First Irradiation Locus
LL2 Second Irradiation Locus
LL3 Third Irradiation Locus
X Perpendicular Direction
Y Given Direction

What is claimed is:

1. A method of joining dissimilar metal plates comprised of a first metal plate and a second metal plate that are made of different materials, the method comprising the steps of:
a placement step of forming an overlapping area where the first metal plate and the second metal plate are placed so as to be overlapped with each other; and
a laser welding step of irradiating a laser beam onto the overlapping area, and reciprocating an irradiation point of the laser beam onto the overlapping area in a perpendicular direction perpendicular to a given direction, while moving the irradiation point in the given direction to form a welded part in the overlapping area along an irradiation locus of a sine-wave shape having a given amplitude in the perpendicular direction,
wherein, in the laser welding step, the laser beam is irradiated onto the overlapping area so that a plurality of irradiation loci are drawn so as to be separated from each other in the perpendicular direction, and when seen in the given direction, one of the irradiation loci adjacent to another of the irradiation loci in the perpendicular direction is overlapped within a range of the amplitude of the other irradiation locus.

2. The method of claim 1, wherein, in the laser welding step, the laser beam is irradiated onto the overlapping area so that three or more irradiation loci are drawn with the same amplitude, without shifting phase, and a pitch of the centers of the amplitudes is an equal interval.

3. The method of claim 2, wherein, in the laser welding step, when drawing the plurality of irradiation loci, the laser beam is irradiated onto the overlapping area on a basis of the irradiation locus drawn in a first time so that the irradiation loci in and after a second time are drawn alternatingly on either side in the perpendicular direction.

4. The method of claim 3, wherein, in the laser welding step, the laser beam is irradiated onto the overlapping area so that the plurality of irradiation loci are all drawn in one way in the given direction.

5. The method of claim 4, wherein, in the laser welding step, a ratio of the amplitude to the pitch is set within a range of 1.3 or more and 3.3 or less for the plurality of irradiation loci.

6. The method of claim 3, wherein, in the laser welding step, a ratio of the amplitude to the pitch is set within a range of 1.3 or more and 3.3 or less for the plurality of irradiation loci.

7. The method of claim 2, wherein, in the laser welding step, the laser beam is irradiated onto the overlapping area so that the plurality of irradiation loci are all drawn in one way in the given direction.

8. The method of claim 7, wherein, in the laser welding step, a ratio of the amplitude to the pitch is set within a range of 1.3 or more and 3.3 or less for the plurality of irradiation loci.

9. The method of claim 2, wherein, in the laser welding step, a ratio of the amplitude to the pitch is set within a range of 1.3 or more and 3.3 or less for the plurality of irradiation loci.

10. A joining apparatus configured to join dissimilar metal plates comprised of a first metal plate and a second metal plate that are made of different materials, the apparatus comprising:
a support base configured to form an overlapping area where the first metal plate and the second metal plate are placed so as to be overlapped with each other;
a laser oscillator configured to oscillate a laser beam; and
a scanner configured to irradiate the laser beam oscillated by the laser oscillator onto the overlapping area, and reciprocate an irradiation point of the laser beam onto the overlapping area in a perpendicular direction perpendicular to a given direction, while moving the irradiation point in the given direction to form a welded part in the overlapping area along an irradiation locus of a sine-wave shape having given amplitude in the perpendicular direction,
wherein the scanner irradiates the laser beam onto the overlapping area so that a plurality of irradiation loci are drawn so as to be separated from each other in the perpendicular direction, and when seen in the given direction, one of the irradiation loci adjacent to each other in the perpendicular direction is overlapped within a range of the amplitude of the other irradiation locus.

11. A joined body of dissimilar metal plates, formed by joining a first metal plate and a second metal plate that are made of different materials, comprising:
an overlapping area wherein the first metal plate and the second metal plate are overlapped with each other; and
a plurality of welded parts, each formed in the overlapping area, extending in a given direction, and having a sine-wave shape with given amplitude in a perpendicular direction perpendicular to the given direction,
wherein the plurality of welded parts are separated from each other in the perpendicular direction, and when seen in the given direction, the sine-wave shape of one of the welded parts adjacent to another of the welded parts in the perpendicular direction is overlapped within a range of the amplitude of the sine-wave shape of the other welded part.
